(19) United States
(12) Patent Application Publication
(10) Pub. No.: US 2011/0210529 A1
(43) Pub. Date: Sep. 1, 2011

(54) METHOD AND APPARATUS FOR ADJUSTING THE GAP OF A FIFTH WHEEL OF A VEHICLE

(75) Inventor: Matthew G. Markstaller, West Linn, OR (US)

(73) Assignee: Daimler Trucks North America LLC.

(21) Appl. No.: 13/036,862

(22) Filed: Feb. 28, 2011

Related U.S. Application Data
(60) Provisional application No. 61/308,874, filed on Feb. 26, 2010.

(51) Int. Cl. B62D 53/08

(52) U.S. Cl. 280/438.1

(57) ABSTRACT

A fifth wheel is movable in fore and aft directions toward and away from the rear wall of a vehicle cab to change the gap between the rear wall and the front wall of a towed trailer. A fifth wheel drive moves the fifth wheel in the respective fore and aft directions including while the vehicle is moving. A fifth wheel controller is operable to control the fifth wheel drive to cause the movement of the fifth wheel in the respective fore and aft directions. The fifth wheel controller can operate in anticipation of the vehicle reaching an upcoming road section to cause the movement of the fifth wheel toward or to a maximum gap position if the gap is not already at the maximum gap position in response to received inputs indicating that additional maneuverability will be required for the vehicle when the vehicle reaches the upcoming road section. The fifth wheel controller can also operate to cause the movement of the fifth wheel toward or to a minimum gap position if the gap is not at the minimum gap position in response to received inputs indicating that additional maneuverability will not be required for the vehicle when the vehicle reaches the upcoming road section and that current vehicle operating conditions do not indicate that additional maneuverability is needed. The fifth wheel controller can also be operable to cause the fifth wheel drive to move the fifth wheel in response to current vehicle conditions.

### CROSS REFERENCE TO RELATED APPLICATION

This application claims the benefit of U.S. Provisional Application Ser. No. 61/308,874, entitled METHOD AND APPARATUS FOR ADJUSTING THE GAP OF A FIFTH WHEEL OF A VEHICLE, filed on Feb. 26, 2010, which is incorporated by reference herein.

### SUMMARY

A vehicle includes a cab with a rear wall. A fifth wheel is movable in fore and aft directions toward and away from the rear wall to respectively decrease and increase the gap between the rear wall of the vehicle and the front wall of a travel trailer. A fifth wheel drive is operably coupled to the fifth wheel for moving the fifth wheel in the respective fore and aft directions including while the vehicle is moving. A fifth wheel controller is coupled to the fifth wheel drive and is operable to control the fifth wheel drive to cause the movement of the fifth wheel in the respective fore and aft directions. The fifth wheel controller can be operable in anticipation of the vehicle reaching an upcoming road section to cause the fifth wheel drive to move the fifth wheel toward or to a maximum gap position if the gap is not already at the maximum gap position in response to received inputs indicating that additional maneuverability will be required for the vehicle when the vehicle reaches the upcoming road section. The fifth wheel controller can also be operable to cause the fifth wheel drive to move the fifth wheel toward or to a minimum gap position if the gap is not at the minimum gap position in response to received inputs indicating that additional maneuverability will not be required for the vehicle when the vehicle reaches the upcoming road section and that current vehicle operating conditions do not indicate that additional maneuverability is needed. The fifth wheel controller can also be operable to cause the fifth wheel drive to move the fifth wheel in response to current vehicle conditions.

### BRIEF DESCRIPTION OF THE DRAWINGS

FIG. 1 is a side elevational view of a truck with a fifth wheel mounted trailer and showing a narrow gap between the trailer and rear wall of the truck.

FIG. 2 is a side elevational view of a truck and trailer with a wider gap between the rear wall of the truck and the front wall of the trailer than the gap shown in FIG. 1.

FIG. 3 is a top view of an embodiment of a fifth wheel that can be moved in fore and aft directions while a vehicle is traveling along a roadway.

FIG. 3A is an end view of a fifth wheel showing exemplary connections of the fifth wheel to a truck mounted support so as to permit fore and aft shifting movement of the fifth wheel.

FIG. 4 is a view similar to FIG. 3 but with components shown in FIG. 4 being enlarged slightly in comparison to those shown in FIG. 3.

FIG. 5 is a schematic illustration of an implementation of a fifth wheel and fifth wheel control system.

FIG. 6 is a schematic illustration of a vehicle approaching a curvy segment of a highway.

FIG. 7 is an exemplary flowchart for a control method for controlling the operation of the fifth wheel.

FIG. 8 is another flowchart setting forth an exemplary method of controlling the fifth wheel in a manual mode.

FIGS. 9-13A and 13B are additional flowcharts of exemplary methods of controlling the movements of the fifth wheel.

### DETAILED DESCRIPTION

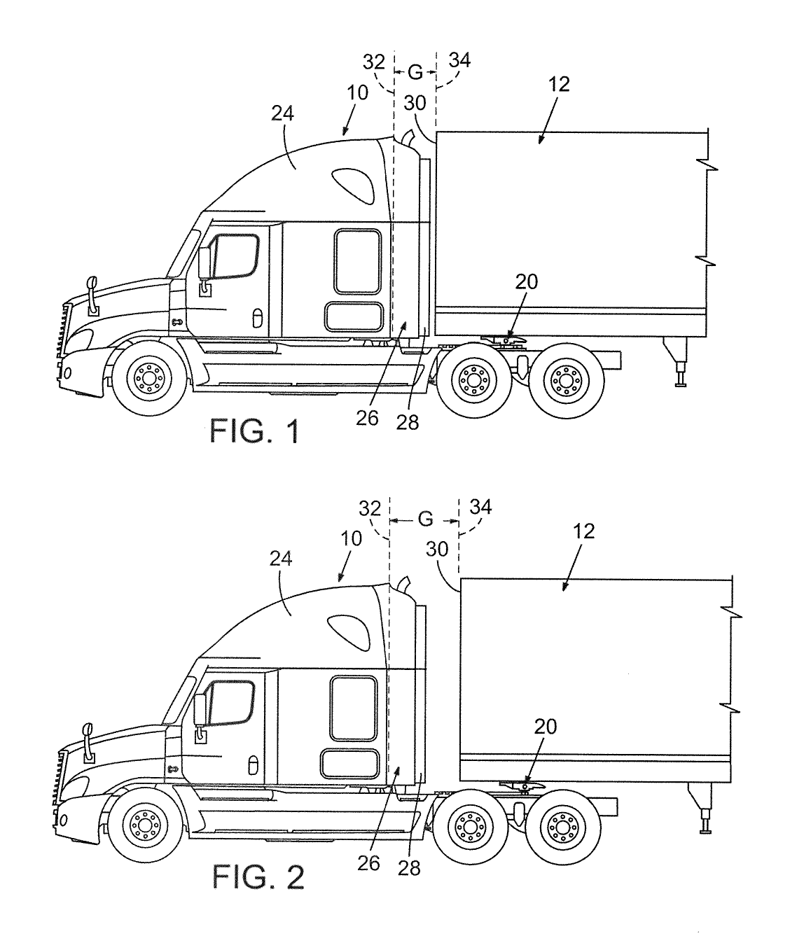

FIG. 1 illustrates a truck 10 towing a trailer 12 with the trailer being coupled to a fifth wheel 20 of the truck. The illustrated truck comprises a roof fairing 24, which can be incorporated into the cab of the truck, together with rearwardly extending side extenders 26 on opposite sides of the vehicle. The side extenders assist in diverting air flowing along the sidewalls of the truck outwardly and along the sides of the trailer. The illustrated side extenders 26 comprise a rear edge portion 28, which can be of a durable but flexible material, such as rubber or a polymer, to avoid damaging the front edge 30 of the trailer in the event the trailer makes a tight turn and the trailer inadvertently engages the edges 28. A gap G exists between the rear wall of the truck cab (indicated generally by dashed line 32) and the front wall 30 of the trailer (indicated generally) by the dashed line 34).

As explained more fully below, the fifth wheel connection 20 is adjustable in fore and aft directions toward and away from the truck cab to thereby shift the trailer 12 toward the cab and/or away from the cab depending upon the adjustment position of the fifth wheel.

FIG. 1 illustrates an exemplary trailer position wherein the gap G is at an exemplary retracted (nearest to the cab) position. In one embodiment, the fifth wheel is moved forwardly to its maximum forward (nearest to the cab) position which is 16 inches closer to the cab than when the fifth wheel is in its rearmost position. As a result, in this specific example, the gap G is 24 inches. The near most position can be different than a position that provides a 24 inch tractor trailer gap. Typically the gap G is set at the near most or smallest distance during conditions where the vehicle is not expected to require high articulation angles (e.g., high turning angles). Since high turning angles are typically required during vehicle maneuvers and/or at low vehicle speeds, the gap can be minimized when these conditions do not exist and/or are predicted not to exist. By reducing the gap, such as at high vehicle speeds when a vehicle is traveling along a highway, the aerodynamic drag of the trailer is significantly reduced, thereby improving fuel economy.

In comparison, in FIG. 2 the trailer 12 is shown mounted to a fifth wheel 20 with the fifth wheel in an exemplary extended (furthest from the cab) position. In one specific example, the fifth wheel is positioned 16 inches rearwardly of its forward most position when the fifth wheel is in its extended position, thereby resulting in a 40 inch gap G. This provides sufficient clearance for high articulation angles during truck maneuvers and/or turning at low speeds. Again, the actual dimensions of the gaps can be varied from the examples discussed above. Also, the fifth wheel can be positioned at positions between the aftmost and forwardmost positions.

It should be noted that, no modifications of the trailer 12 is required (e.g., existing trailer designs can be used) as the fifth wheel can have a cab to trailer connection that is the same as found in existing fifth wheels. Alternative side extenders, roof fairings or caps, between trailer and cab access features, can also be included if desired.

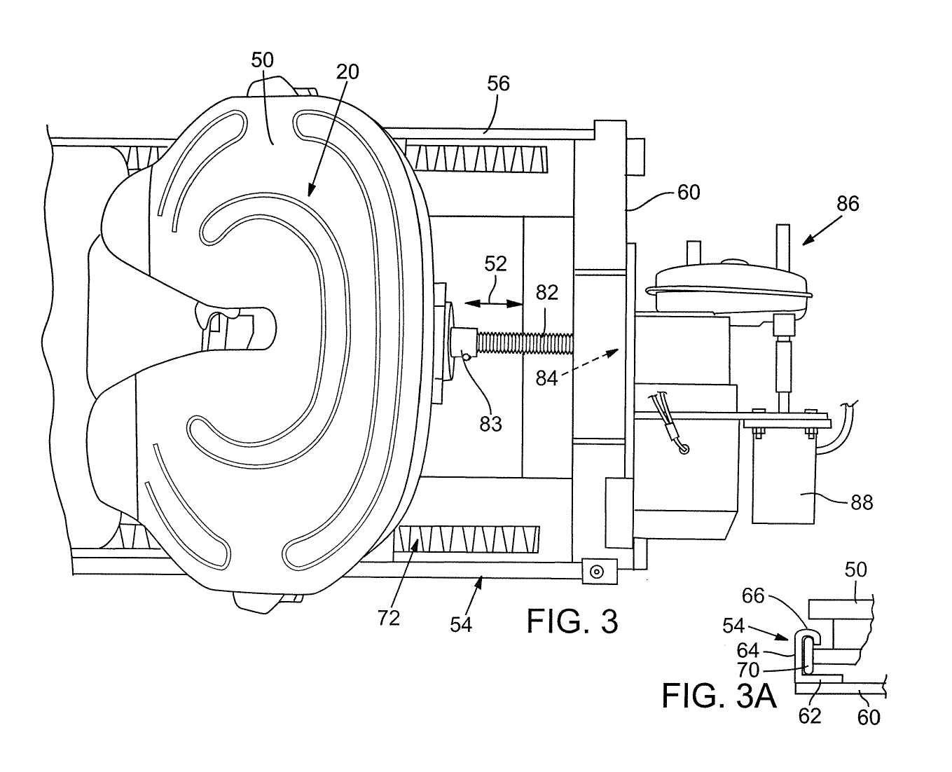

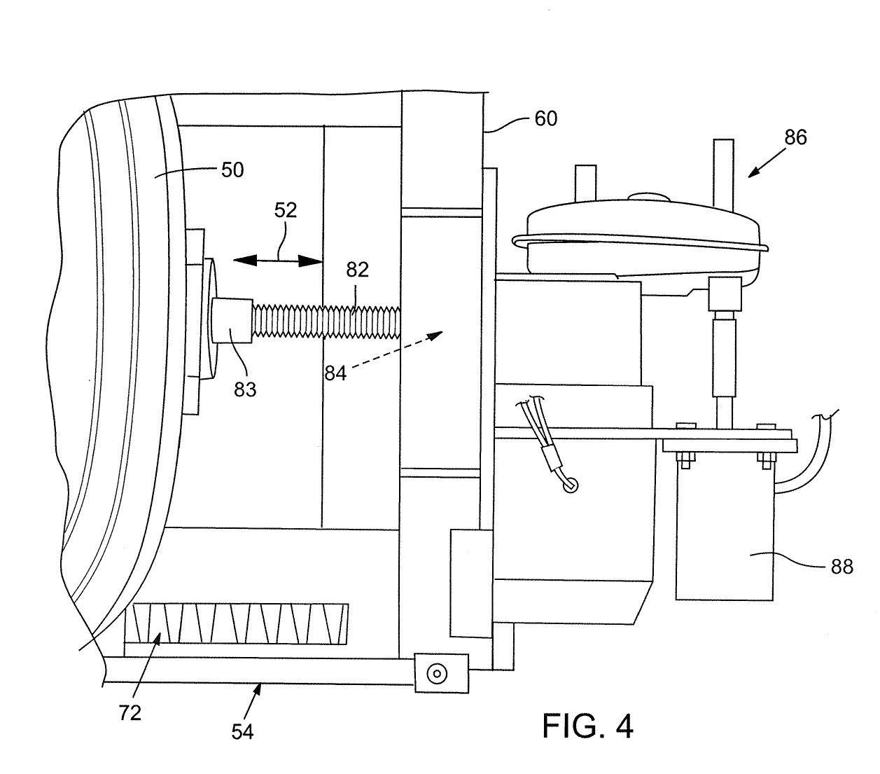

One embodiment of a mechanism for adjusting the position of the fifth wheel is shown in FIGS. 3, 3A and 4. In these figures, the entire fifth wheel assembly is indicated generally by the number 20. The exemplary actual fifth wheel mechanism for coupling the cab to the trailer is indicated at 50 in these figures. The fifth wheel 50 is supported by a support frame for sliding movement in fore and aft directions indicated by double-headed arrow 52. The support frame can comprise first and second rails 54, 56 mounted to a truck tractor fifth wheel supporting framework 60. An exemplary rail 54 (see FIG. 3A) comprises a base portion 62, an upright leg portion 64 and a fifth wheel capturing portion 56 that overhangs and captures a portion 70 of the fifth wheel to permit the fore and aft sliding movement. The two spaced apart rails 54, 56 cooperate to fix the position of the fifth wheel, both laterally (in a transverse direction perpendicular to arrow 52) and vertically, while allowing the fore and aft movement. The teeth shown in these figures (see number 72 located along the respective siderails 54, 56, only the teeth positioned next to framerail 54 being numbered) can be eliminated in a typical example. The mounting structure comprising framework 60, 62, 64, 66, 70 and 50, with the teeth 72, is a conventional approach for mounting a fifth wheel to a truck. However, in this known example, the fifth wheel is moved to a desired position and then locked by locking mechanisms to hold the fifth wheel in place. This construction does not allow the fifth wheel to move during travel of the vehicle along a highway.

In accordance with this disclosure, a fifth wheel drive mechanism is provided for adjusting the fore and aft position of the fifth wheel, and can perform this adjustment as the vehicle is moving. In one desirable form, the fifth wheel adjustment mechanism comprises a screw jack assembly including an actuating screw 82 that threadedly passes through a screw supporting nut 83 that is coupled to or mounted to a support that supports the fifth wheel. A forward end portion 84 (indicated by dashed lines in FIG. 3) is drivenly coupled to a drive mechanism, such as a gear reduction drive 86, driven by a motor 88 in response to drive motor control signals. The distal end of the screw actuator 83 (not shown in FIG. 3) spaced from end portion 84 can be supported by a bearing. With this construction, rotation of the actuator screw in one direction causes the nut and fifth wheel to move in a forward direction. In contrast, rotation of the actuator screw in the opposite direction causes the nut and fifth wheel to move in an aft direction. In addition, the use of an actuating screw positively locks the fifth wheel in its set position because the fifth wheel cannot move without the actuator screw being rotated. One or more position sensors can be utilized to detect the position of the fifth wheel. For example, a first position sensor can be used to determine the positioning of the fifth wheel in the forward most position and a second position sensor can be used to detect the positioning of the fifth wheel in a rearward most position. Position sensor signals can be delivered to a controller for use in controlling the fifth wheel positioning. Alternatively, motor 88 can be a step motor with the positioning of the fifth wheel being determined by the number of drive steps and with a feedback circuit being utilized to confirm the fifth wheel position. Other forms of actuator drive motors can be used, such as hydraulic or pneumatic drive motors. Most desirably, although alternatives can be used, an actuating screw drive is utilized for fifth wheel movement.

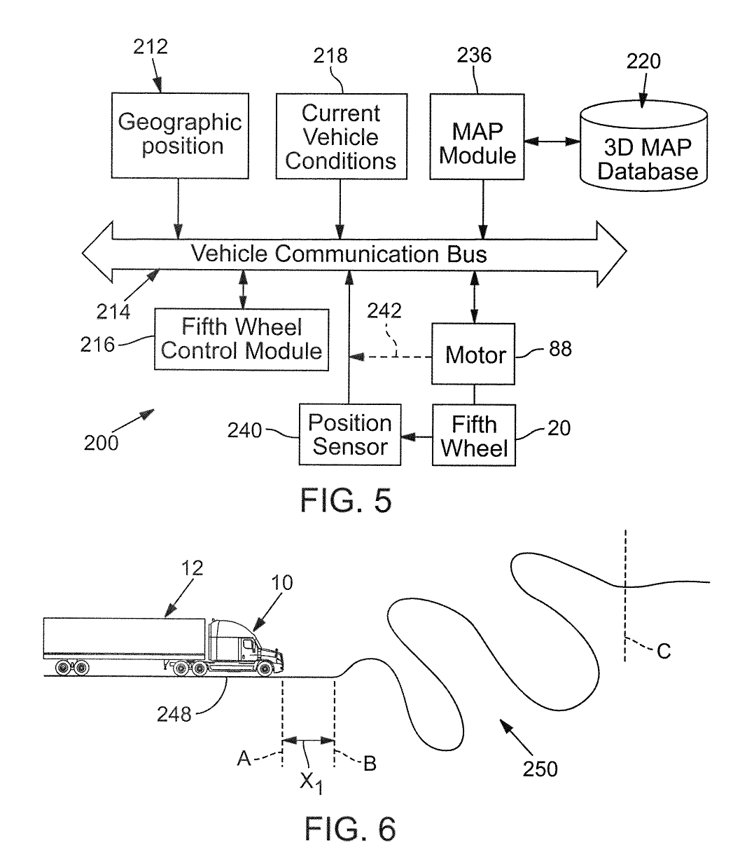

FIG. 5 illustrates an embodiment 200 of a fifth wheel positioning system in combination with other vehicle components. In FIG. 5, a block 212 is shown that comprises a GPS receiver to provide geographic position information indicating the location of the vehicle. The exemplary block 212 comprises a GPS receiver that receives GPS signals from which the latitude and longitude of the instantaneous vehicle position can be obtained or computed. Position signals can be communicated from block 212 to a conventional communications databus 214 and from the bus 214 to a fifth wheel control module 216 that can control the fifth wheel position.

A three dimensional map database 220 can be provided that can store longitude and latitude information. Other information can also be stored in the map database, such as speed limit information for route segments and road curve information. Thus, assuming the information is available for a given route, or route segment, the 3D database can contain data that includes speed and other information corresponding to contour (elevation) changes along the route correlated to the position along the route. Speed limit information can be added and updated in any convenient manner, such as from a speed limit database or by wireless data inputs. The road curvature (such as curve radius and curve banking) information in the map database can be obtained and stored in any convenient manner, such as from road data information. Alternatively, the data can be gathered by one or more trucks traveling over a given route. When a desired number of trips have taken place over the given route, the data may be combined, such as by averaging, to create the road information.

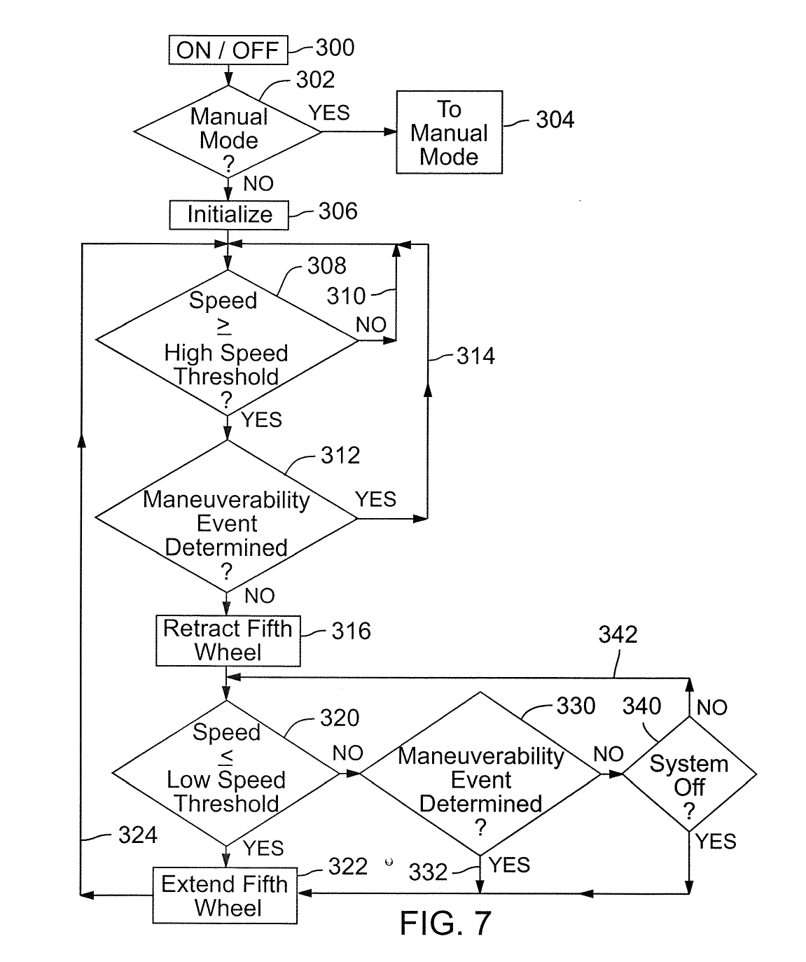

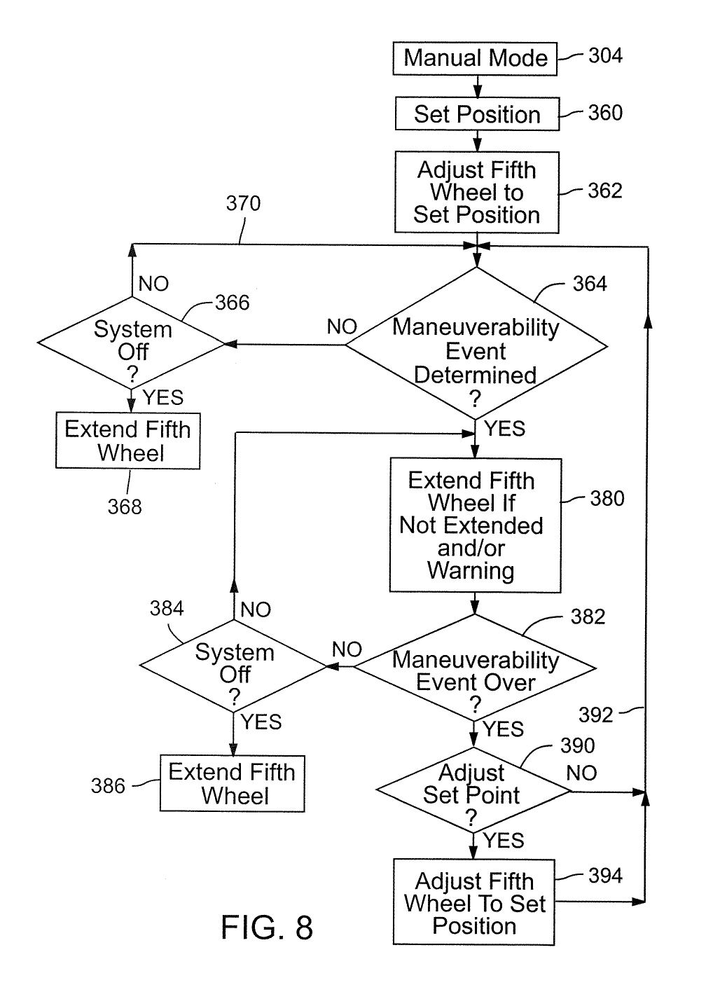

These signals can be communicated to the vehicle databus 214. The fifth wheel controller 216 (which can be discrete and/or combined into other existing vehicle controllers) receives these and other signals from the databus for use in determining the desired fifth wheel position. Signals from sensors or other input devices corresponding to a variety of current vehicle conditions, indicated at block 218, are communicated to the vehicle communication bus and thus are also available to control module 216. A list of exemplary instantaneous vehicle conditions comprises vehicle speed, fifth wheel position, braking events [such as braking exceeding a threshold such as determined by the controller from and/or indicted by a signal corresponding to brake pedal position], steering angle [determined by the controller and/or indicated by a signal from, for example, a steering wheel angle sensor indicating the steering angle and such as the steering angle being in excess of a threshold for a given vehicle speed, such as can be stored in a look up table or otherwise with, for example, different threshold values for different vehicle speeds], ABS (antilock braking system) activation [determined and/or indicated by an ABS activation signal], vehicle stability signals (e.g., yaw rate or yaw change [signal(s) from one or more yaw rate sensors from which the controller can determine and/or that indicate that vehicle yaw rate is in excess of a threshold, yaw being the angle of the tractor of a semi-truck from the direction of travel and yaw rate being the change in yaw] and/or the relative angle between the tractor and a towed trailer [signal(s) from one or more sensors, such as a laser angle measuring device, from which the controller can determine and/or that indicate that relative angle between the tractor and towed trailer is in excess of a threshold], wheel steering angles), and other maneuvering indicating signals, that indicate the position of the fifth wheel should be altered. Data can be stored in a look up table, such as steering wheel angles for different speeds, which, if a threshold is exceeded, indicates that the gap distance should be increased. One or more of these signals can be used in the fifth wheel position control. The thresholds can be varied with vehicle operating conditions. The phrase in excess of or exceeding a threshold is to be broadly construed so that if a level is equal to a value, it is in excess of a threshold because the threshold is then a value below the equal value level. The fifth wheel controller can comprise a special or general purpose digital computer with memory that is programmed with instruction steps to provide fifth wheel motor control signals on a data bus 214 (or otherwise) to a fifth wheel drive, such as to the motor 88, to cause the adjustment of the position of the fifth wheel. Exemplary control approaches are set forth in FIGS. 7 and 8, as described below.

The map module 236 can be provided with knowledge of the instantaneous position of the vehicle (from signals on the data bus or in response to a map request from fifth wheel position control module 216) and can fetch data from the 3D MAP database 220 corresponding to an upcoming section of a route or expected route (e.g., the next two to five miles). This upcoming route section can be termed a prediction horizon. If the GPS location or position signal indicates the vehicle has deviated from the expected route section (e.g., taken a freeway exit), a new expected route section can be selected as the next prediction horizon or window. Respective windows can be opened to correspond to successive or otherwise selected route windows such that route information processing can be accomplished simultaneously in more than one such window.

The window or route segments need not be of a constant length, although this can be desirable. For example, when traveling over terrain known to be substantially flat (e.g., portions of Nebraska), the fifth wheel position management controller can select windows of extended length. Alternatively, instantaneous conditions can be used for fifth wheel position determination. The fifth wheel position management control module can then determine a desired fifth wheel position for this upcoming section of the route. Desirably, the map module 136 retrieves an upcoming prediction window as data related to the just traversed prediction window is discarded so that calculations can be made rapidly on an ongoing basis.

The fifth wheel control module can deliver motor control signals via bus 214 to motor 88 to control the operation of the motor to thereby control the position of the fifth wheel 20 in the desired fore and aft directions. One or more position sensors 240 can be used to provide signals via the communication bus to the fifth wheel control module 216 to indicate when the desired fifth wheel position has been reached, at which time the operation of motor 88 can be stopped. Dashed line 242 indicates alternative feedback signals that can be provided to the fifth wheel control module via the databus to confirm the position of the fifth wheel.

With reference to FIG. 6, assume a truck 10 pulling a trailer 12 is traveling along a section of a roadway 248. Also assume that from the map data information a determination is made that at location B a series of switchbacks 250 will be encountered by the vehicle. As a result, added maneuverability of the vehicle may be needed at location B. Consequently, in response to this determination the fifth wheel control module can, as the vehicle reaches location A, a distance X₁ before location B, cause the fifth wheel to be shifted to an extended (aft) position so that when the vehicle reaches position B the gap will be increased to enhance the maneuverability of the vehicle. In other words, a predictive control of the fifth wheel position is accomplished. Other high maneuverability events can also be predicted, such as a selected route indicating that a ramp exit will be taken at a particular location. The fifth wheel position can be dynamically adjusted in anticipation of these predicted higher maneuverability events and/or based on instantaneous determinations. Alternatively, instantaneous control can be used. For example, when location B is reached, from steering angle information and/or stability information (yaw rate sensor information) a determination can be made by controller 216 to extend the fifth wheel position in an aft direction. Conversely, if speed and road information indicate that the vehicle will be traveling along a straight section of road with relatively high freeway speeds being permitted, the fifth wheel control module can retract the fifth wheel to move the trailer toward the truck tractor. Other conditions can be utilized to control the fifth wheel position. For example, in the event of a hard braking or rapid braking event, determined from brake pedal control signals, either alone or in combination with steering angle changes, the fifth wheel control module can be operated to extend the fifth wheel position to move the trailer further away from the truck tractor for enhanced maneuverability. As another example, if a signal from an antilock braking system indicates the antilock braking system is in operation, the fifth wheel control module can be operated to shift the fifth wheel rearwardly in anticipation of needing additional maneuverability in view of the operation of the ABS system.

In general, when vehicle conditions indicate that additional maneuverability of the vehicle may be desired, the fifth wheel can automatically be shifted to one or more and/or the most extended position. Conversely, under conditions where high maneuverability is not required, the fifth wheel can be moved closer to the rear wall of the tractor. Also, because higher steering angles are typically encountered at lower vehicle speeds and less sharp steering angles are encountered at higher vehicle speeds, the fifth wheel can be shifted forwardly at high vehicle speeds, such as above or equal to a threshold (e.g., 55 miles per hour being one example of a high speed threshold, although variable). Conversely, if the speed drops below a low speed threshold (e.g., less than or equal to 35 miles per hour), the fifth wheel can be automatically moved to an extended or rear position. A hysteresis can be incorporated into the control system so that, for example, the fifth wheel position is not changed (e.g., the fifth wheel is not extended after the high vehicle speed threshold is reached until the low vehicle threshold speed is reached and is not thereafter retracted until the high vehicle threshold speed is again achieved). In addition, a maneuverability event (e.g., where additional maneuverability of the vehicle may be required) can result in the fifth wheel being extended automatically.

In addition, a manual mode can be incorporated into the control with the vehicle driver, for example, being able to establish the fifth wheel position. The fifth wheel position can be fixed at this established position until the driver again adjusts the position. Alternatively, the fifth wheel position (even in the manual mode) can be automatically adjusted to an extended position if a maneuverability event is determined to exist.

As another option, in a simplified control approach, the fifth wheel can, for example, be retracted only when a determination is made that the vehicle is or will be traveling on a freeway or other high speed roadway.

Although different control strategies can be used, one exemplary control approach is shown in FIGS. 7 and 8. In FIG. 7, at block 300, the system is turned on or off. If off, shifting of the fifth wheel position is blocked. If on, a block 302 is reached and a determination is made as to whether a system is in a manual mode. If the answer is yes, at block 304 the manual mode control strategy is followed. One example of the manual mode strategy is shown in FIG. 8 as discussed below.

If the manual mode is off, from block 302 a block 306 is reached and the system is initialized. For example, the fifth wheel can be moved to an extended (most maneuverable) vehicle position. Alternatively, the fifth wheel position can simply be detected and then shifted (extended if low speed or maneuverability events are detected or predicted, or retracted if high speed and no maneuverability events are detected or predicted). Assume at block 306 the fifth wheel is extended to its maximum extended position. At block 308, a determination is made as to whether the speed is greater than or equal to a high speed threshold (e.g., 50 to 60 miles per hour, with 55 miles per hour being one specific example). If the answer is no, a branch 310 is followed, returning the process to block 308. Instead of, or in addition to this block 308 approach, a speed determination can be made at block 308 as to whether the vehicle is or will be traveling along a high speed section of a highway. If the answer at block 308 is yes, a block 312 is reached and a determination is made as to whether a maneuverability event has taken place or is predicted. Examples of these maneuverability or desired maneuverability events have been discussed previously, such as cycling of an ABS system, a hard braking event, a steering angle being greater than a threshold, a hard braking event in combination with a specified steering angle, a vehicle instability determination (e.g., from yaw rate sensors and/or steering wheel angle sensors), or a predictive event such as an upcoming section of road where switchbacks exist and/or where low speeds will be encountered. If the answer at block 312 is yes, a branch 314 is followed back to block 308 and the process continues. If the answer at block 312 is no, a block 316 is reached and the fifth wheel is retracted (moved forwardly toward the tractor, such as to its maximum forward position). From block 316, a block 320 is reached wherein a determination is made whether the speed is less than or equal to a low speed threshold. Again, a predictive determination can be made at this block. If the answer at block 320 is yes, a block 322 is reached. In this case, the fifth wheel is moved to an extended (aft) position and the process continues via a line 324 to the block 308. If the answer at block 320 is no, a block 330 is reached and a determination is made as to whether a maneuverability event has been determined and/or is predicted. If yes, a line 332 is followed to a line 334 and the block 322 is reached and the fifth wheel is extended. If the answer at block 330 is no, a block 340 is reached, at which a determination is made as to whether the system has been turned off. If the answer is yes (and assuming a default condition is that the fifth wheel is extended), the block 322 is again reached, the fifth wheel is extended and the process continues via line 324 to the block 308. If the system remains on, from block 340 a line 342 is followed back to the block 320 and the process continues.

Again, this is an exemplary control approach as other alternative approaches can be used.

With reference to FIG. 8, if the manual mode has been selected at block 304, a block 360 is reached, allowing the vehicle operator to set a desired fifth wheel position (e.g., extended, retracted or at some position therebetween). If the position set at block 360 is different from the position at which the fifth wheel is then in, a block 362 is reached and the fifth wheel position is adjusted to the set position. From block 362, a block 364 is reached, at which a determination is made as to whether a maneuverability event exists or is predicted. If the answer is no, a block 366 is reached, at which a determination is made as to whether the system is off. If the system is off, a block 368 is reached and the fifth wheel is extended (assuming the extended fifth wheel position is a default condition). If the system is not off, a line 370 is followed back to the block 364 and the process continues. In contrast, if a maneuverability event is determined or predicted at block 364, a block 380 is reached and the fifth wheel is extended, if it is not already extended and/or a warning signal is provided to the driver. In this disclosure the phrase “and/or” means “and”, “or” and both “and” and “or”). In addition, the term coupled means both direct connection and indirect connection through one or more intermediate elements.

From block 380 a block 382 is reached and a determination is made as to whether the maneuverability event (or predicted event conditions) has ended. If the answer is no, a block 384 is reached and a determination is made as to whether the system is off. If the answer is yes at block 384, and assuming the default condition is to extend the fifth wheel, at block 386 the fifth wheel is extended. If the system is on at block 384, the process continues back to block 380. If at block 382 a determination is made that the maneuverability event has ended, a block 390 is reached and a determination is made as to whether the set point is to be adjusted. If the answer is no, a line 392 is reached and the process continues to block 364. If at block 390 a determination is made that the set point is to be adjusted, a block 394 is reached from block 390 and the fifth wheel position is adjusted to the set position. From block 394, the line 392 is again reached and the process continues at block 364.

Again, this is one example of a manual mode as the mode may be varied as desired.

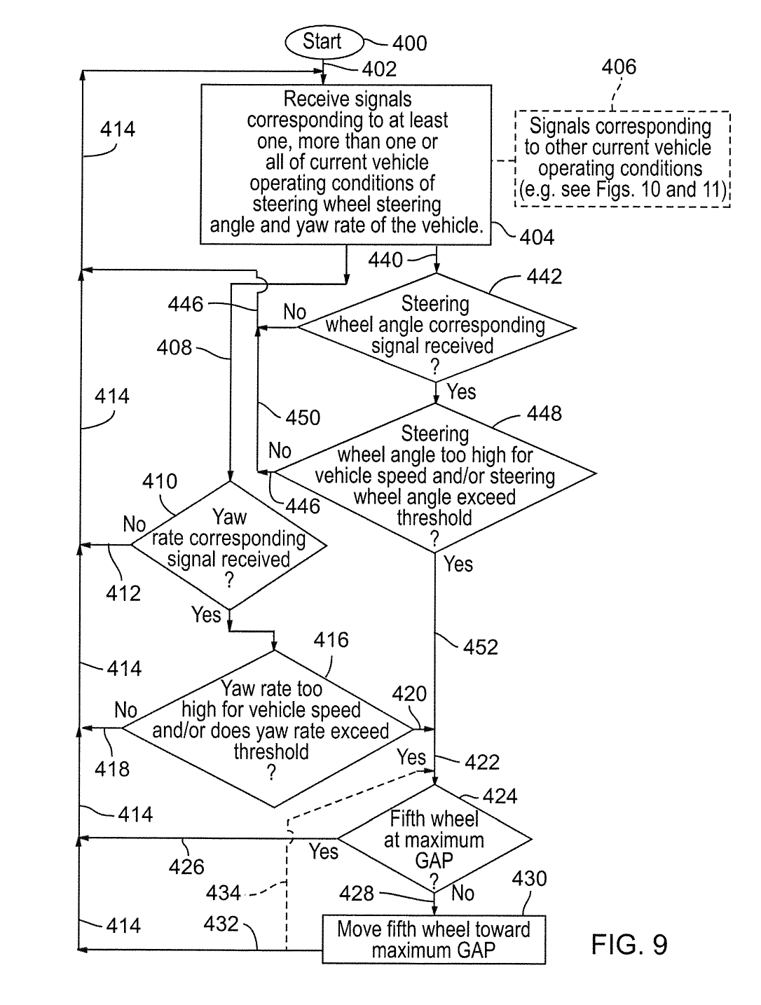

Additional examples of control methods or strategies for operating the controller are illustrated in FIGS. 9-13.

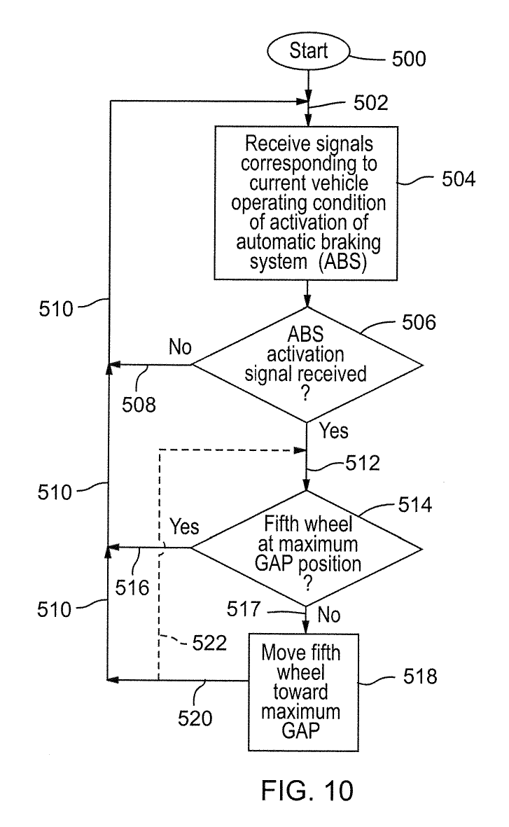

With reference to FIG. 9, from start block 400, a line 402 is followed to a block 404 relating to received data inputs or signal inputs. In block 404, signals for processing are received that correspond to at least one, more than one, or all of current vehicle operating conditions of interest. In the embodiment of FIG. 9, these current vehicle operating conditions are one or more or all of a steering wheel steering angle and yaw rate of the vehicle. A side block 406 simply indicates that one or more additional signals can also be processed such as a signal indicating whether an automatic braking system (ABS) of the vehicle is activated (see FIG. 10), signals relating to hard braking events, signals relating to current vehicle speed, adaptive cruise control signals or traffic sensors indicating an accident is ahead (in which case the gap would be extended), relative tractor/towed trailer angle signals (an angle that exceeds a threshold indicating that the gap should be extended), and other stability control and/or vehicle auxiliary control system signals.

In FIG. 9, one branch leading from block 404 follows a line 408 to a block 410 at which a determination is made whether the yaw rate corresponding signal has been received. A no answer follows line 412 to a line 414, which returns the process to line 402 and back to block 404. If the answer at block 410 is yes, a block 416 is reached at which a determination is made as to whether the yaw rate is too high for the current vehicle speed and/or whether the yaw rate exceeds a threshold. This determination can be made from, for example, a stored look up table of yaw rate versus vehicle speed threshold values. If the answer at block 416 is no, a line 418 is followed to line 414 and the process continues back at line 402 as previously discussed. If the answer at block 416 is yes, corresponding to the yaw rate of the vehicle being too high indicating that more vehicle maneuverability is required, a line 420 is followed to a line 422 and a block 424 is reached. At block 424, a check is made as to whether the fifth wheel is at its maximum gap. If the answer is yes, a line 426 is followed back to line 414. Under these conditions the fifth wheel is already at its position for maximum vehicle maneuverability. If the answer at block 424 is no, a line 428 is followed to a block 430 and the fifth wheel is moved toward the maximum gap position. From block 430 a line 432 can be followed back to line 414. Under this approach, if the fifth wheel is being moved toward its maximum gap position and the yaw rate returns to a condition where increased maneuverability is not needed, an optional process block (not shown) can be reached to stop movement of the fifth wheel under these conditions. Alternatively, from block 430 and line 432 a line 434 can be followed back to line 422, in which case the movement of the fifth wheel will continue until the fifth wheel has reached its maximum gap position.

As an alternative or alternate branch, from block 404 a line 440 can be followed to a branch relating to steering wheel angle or vehicle steering as one of the current vehicle operating conditions being evaluated. From line 440, at a block 442 a question is asked as to whether the steering wheel angle corresponding signal has been received. If the answer is no, a line 444 is followed to a line 446 and back to the line 414 and the process continues. If the answer is yes at block 442, a block 448 is reached where an evaluation is made of the steering wheel angle signal. For example, at block 448 a determination can be made as to whether the steering wheel angle is too high for the current vehicle speed and/or does the steering wheel angle exceed a threshold. If the answer is no, a line 450 is followed to the line 446 and the process continues. If the answer at block 448 is yes, a line 452 is followed to the line 422 and the process can continue as previously described.

FIG. 9 thus illustrates an exemplary method of evaluating one or more or all of the steering wheel steering angle and yaw rate current vehicle operating conditions.

FIG. 10 illustrates a control strategy that operates in response to the evaluation of the activation of a vehicle's automatic braking system (ABS) if the vehicle has such a system. This vehicle operating condition can be evaluated separately or as one of the one, more or all of the conditions evaluated for use in the example of FIG. 9. In FIG. 10, from a start block 500 a line 502 is followed to a block 504 at which signals corresponding to the current vehicle operating condition of whether the automatic braking system has been activated are received. From block 504, a block 506 is reached at which a determination is made as to whether the ABS activation signal has been received. The ABS activation signal is a standard signal available on a vehicle bus for a vehicle such as a truck. Activation of the ABS system is an indicator in this example that higher vehicle maneuverability is desired. If a signal has not been received indicating that the ABS system has been activated, a “no” line 508 is followed from block 506 to a line 510 with the process returning to line 502. In contrast, if no ABS activation has been indicated, a line 512 is followed to a block 514 at which a determination is made as to whether the fifth wheel is at its maximum gap position. If the answer is yes, a line 516 is followed to the line 510 and the process continues. If the answer at block 514 is no, a line 517 is followed to a block 518 and the fifth wheel is moved toward the maximum gap. From block 518, the process can continue via a line 520 to the line 510 and back via line 502 to block 504. If the process at block 506 determines that the ABS activation signal has ended and the fifth wheel has not been moved to its maximum gap, an optional block (not shown) can be followed to interrupt the movement of the fifth wheel toward the maximum gap position. As an alternate approach, from block 518 and line 520, a line 522 can be followed back to line 512 in which case the fifth wheel would continue to be moved toward its maximum position until it reaches its maximum position in response to a signal indicating that the ABS system has been activated.

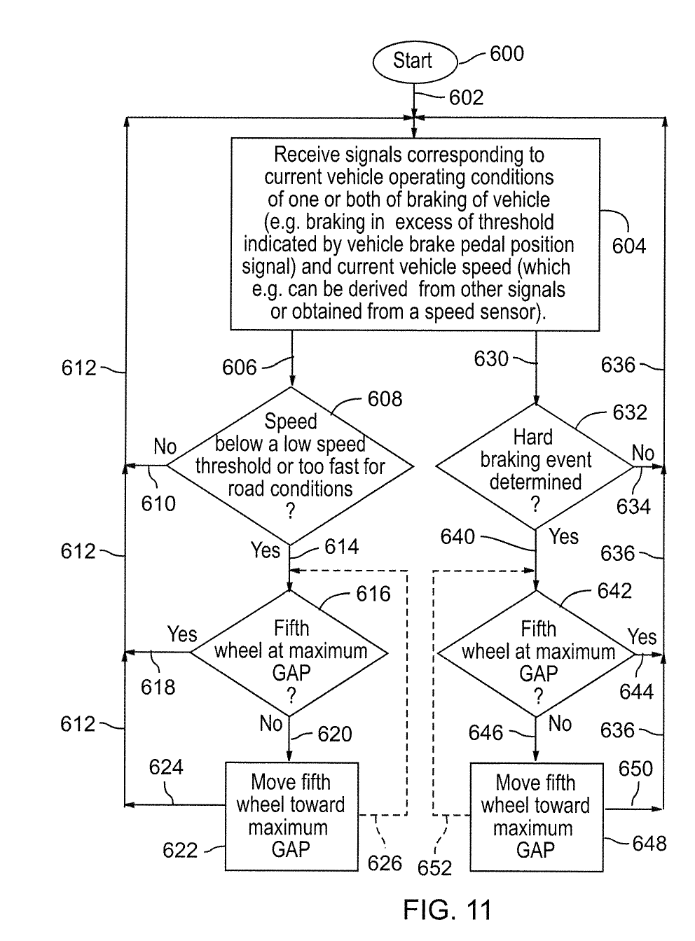

FIG. 11 is an example of a control strategy wherein the current vehicle conditions also can include one or more of whether there is a hard braking event and current vehicle speed. These conditions can be evaluated in addition to or alternatively to the conditions discussed above in connection with FIGS. 9 and 10.

With reference to FIG. 11, from a start block 600, a line 602 is followed to a block 604 indicating the receipt of signals corresponding to current vehicle operating conditions of one or both of braking of the vehicle (e.g., braking in excess of a threshold indicated by, for example, a vehicle brake pedal position indicating signal available, for example, on a vehicle data bus) and current vehicle speed (which, for example, can be derived from other signals, such as from vehicle acceleration or obtained from a speed sensor).

Assume that signals corresponding to vehicle speed are being evaluated. In this case a branch 606 is followed to a block 608 at which a determination is made as to whether the speed is below a low speed threshold or too fast for current road conditions. For example, the vehicle may be traveling at a speed that is higher than the posted speed limit, such as a speed limit determined from a map database for the then current vehicle position. If the answer at block 608 is no, a line 610 is followed to a line 612 and the process returns to line 602 and back to block 604. If the answer at block 608 is yes, a line 614 is followed to a block 616 at which a determination is made as to whether the fifth wheel is at its maximum gap position. If the answer is yes, the fifth wheel is in the position for maximum vehicle maneuverability and a line 618 is followed to line 612. If at block 616 the answer is no, a line 620 is followed to a block 622 at which the fifth wheel is moved toward the maximum gap position. The process can continue along a line 624 back to the line 612 and via the line 602, block 604, block 608 and back to block 616. An optional block can be included (not shown in this figure) that interrupts the movement of the fifth wheel toward the maximum gap position if the speed has increased above the low speed threshold, such as having reached a high speed threshold, or the speed is no longer too fast for the current road conditions. Alternately, from block 622 a line 626 can be followed back to line 614 and again to block 616. If the approach of line 626 is followed, this process would continue until the fifth wheel has been moved to its maximum gap position.

If the current vehicle operating condition being evaluated includes whether a hard braking event has been determined, from block 604 a hard braking event branch along line 630 can be followed to a block 632. At block 632 a determination is made as to whether a hard braking event has occurred. For example, a signal on a vehicle bus indicating that the position of a throttle pedal, in the case of an electronic throttle, for example, has exceeded a threshold. If the answer is no at block 632, a line 634 is followed to a line 636 and the process returns to line 602 and back to block 604. If the answer at block 632 is yes, a line 640 is followed to a block 642 and a determination is made as to whether the fifth wheel is at its maximum gap position. If the answer is yes, a line 644 is followed to the line 636 and back to the line 602 with the process continuing. In this case, the fifth wheel is in its position for maximum maneuverability of the vehicle. If the answer at block 642 is no, a line 646 is followed to a block 648 and the fifth wheel is moved toward the maximum gap position. From block 648, a line 650 can be followed to line 636 and back to line 602, block 604 and via block 632 to the block 642. An optional block can also be included (not shown), that interrupts the movement of the fifth wheel toward the maximum gap position if the hard braking event is determined at block 632 to have ended. As another control strategy, from block 648, instead of following line 650, a line 652 can be followed back to line 640 and again to block 642. This loop would continue until such time as the fifth wheel has been moved to its maximum gap position.

Thus, FIG. 11 illustrates yet another exemplary control strategy for evaluating vehicle operating conditions of whether a hard braking event has occurred and vehicle speed.

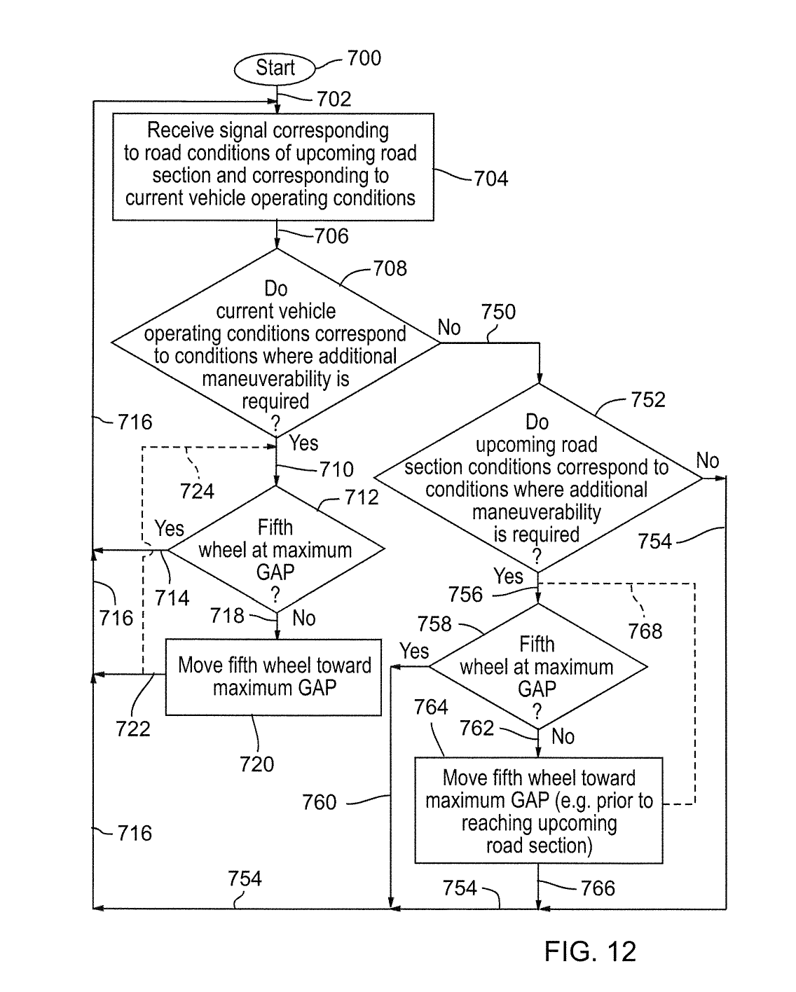

FIG. 12 is an example of a control strategy that can be followed in the event predictive control of the fifth wheel gap is also desired. Predictive control refers to moving the fifth wheel based on conditions of upcoming road sections to be traveled by a vehicle, with the fifth wheel then being moved in anticipation of the upcoming road section conditions so that when the upcoming road section is reached, the fifth wheel is in a position for the desired maneuverability. Various upcoming road conditions can be evaluated including, but not limited to, one or more of the curvature of the road, the banking of the road, elevation changes in the road, speed limits. Also, changing road conditions, such as traffic and expected weather can also be considered.

With reference to FIG. 12, from a start block 700, a line 702 is followed to a block 704. At block 704, signals corresponding to road conditions of an upcoming road section to be traveled by the vehicle are received along with signals corresponding to current vehicle operating conditions. The road condition signals can be, for example, data inputs from data stored in a map database. This data can be stored, for example, as attributes to road or route sections. The route can be one that has been entered, such as by an operator of the vehicle, or determined by a navigation system. The current vehicle position can be determined, for example, from vehicle position signals such as GPS signals received by an onboard GPS receiver. The signals corresponding to current vehicle operating conditions can be signals such as previously discussed. It should be noted that these signals can be preprocessed prior to delivery so that, when received by a fifth wheel drive controller, they indicate, for example, that a threshold has been exceeded. Conventional sensors can be utilized to obtain current vehicle operating conditions. In addition, the current vehicle operating conditions can include environmental conditions (such as temperature and weather). For example, if the temperature is below freezing the controller can maintain the fifth wheel at its maximum gap position if desired.

From block 704 a line 706 is followed to a block 708. At block 708 a determination is made as to whether current vehicle operating conditions correspond to conditions where additional maneuverability is required. For example, activation of the antilock braking system (ABS) may have been indicated. If the answer at block 708 is yes, strategies such as described previously in connection with FIGS. 9-11 can be followed. In FIG. 12 a control strategy follows a line 710 from block 708 under these conditions to a block 712 at which a determination is made as to whether the fifth wheel is at its maximum gap. If the answer is yes, a line 714 is followed to a line 716 and back to line 702 and block 704 and then to block 708 with the process continuing. Line 714 is reached under conditions where additional maneuverability is indicated by the vehicle operating conditions and the fifth wheel is already at its maximum maneuverability position. If the answer at block 712 is no, a line 718 is followed to a block 720. At block 720 the fifth wheel is moved toward its maximum gap position. From block 720 a line 722 can be followed to line 716 and back to line 702 with the process continuing. One or more blocks can be added to the process to interrupt the movement of the fifth wheel toward the maximum gap position if the current operating conditions no longer indicate that additional maneuverability is required. As an option, from line 722, instead of returning to line 716, a line 724 can be followed back to line 710 and to block 712. This loop would continue until the fifth wheel has reached its maximum gap position.

Returning again to block 708 of FIG. 12, assume at this block that the current vehicle operating conditions do not correspond to conditions where additional maneuverability is required. Nevertheless, upcoming road section conditions may still indicate the vehicle is approaching a road section where additional maneuverability will be required. In an exemplary strategy where upcoming road section conditions are being evaluated, from block 708 a line 750 is followed to a block 752 at which a determination is made as to whether upcoming road section conditions correspond to conditions where additional maneuverability may be required. If the answer at block 752 is no, a line 754 is followed back to line 716 with the process continuing. Instead, if the answer is yes at block 752, a line 756 is followed to a block 758 and a determination is made as to whether the fifth wheel is at its maximum gap position. If the answer is yes, the fifth wheel is in position for maximum maneuverability and a line 760 is followed to the line 754 with the process continuing. If the answer at block 758 is no, a line 762 is followed to a block 764. At block 764 the fifth wheel is moved toward its maximum gap position. This movement typically occurs prior to reaching the upcoming road section, although it can be started immediately upon reaching the upcoming road section or at a later time. From block 764, a line 766 is followed to line 754 with the process continuing via line 716 back to line 702. One or more blocks can be included in the process to interrupt the movement of the fifth wheel toward the maximum gap position if the upcoming road section conditions have changed such that additional maneuverability is no longer required and current vehicle operating conditions do not indicate that additional maneuverability is required. As an alternate control strategy, from block 764, a line 768 can be followed back to line 756 and to block 758 with the process continuing via a loop and the fifth wheel being moved until the maximum gap has been reached.

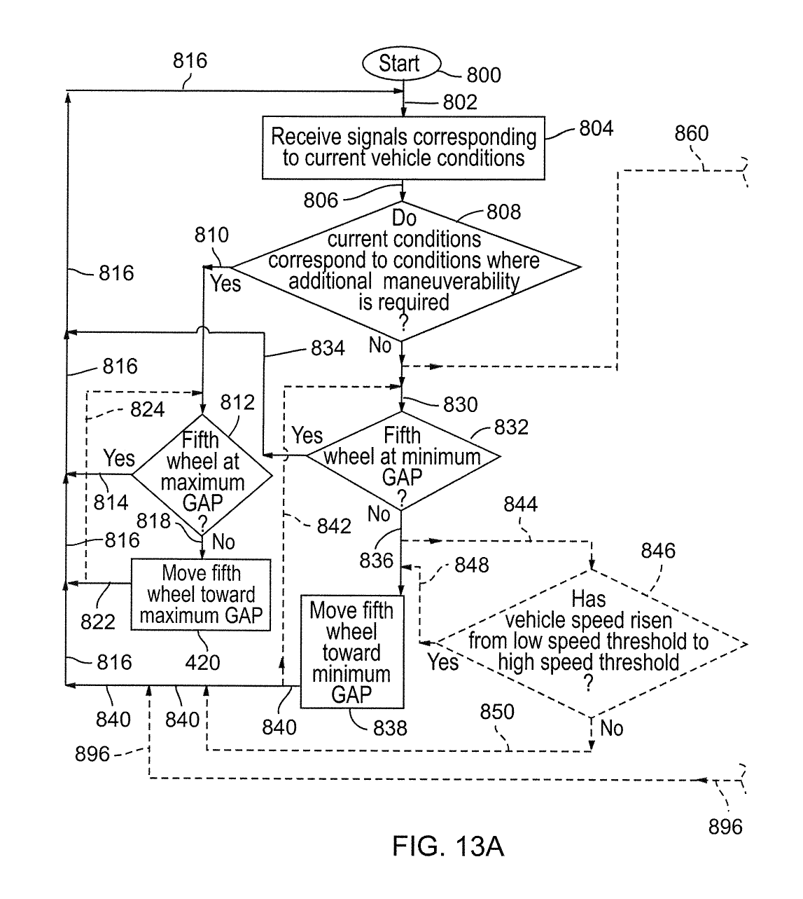

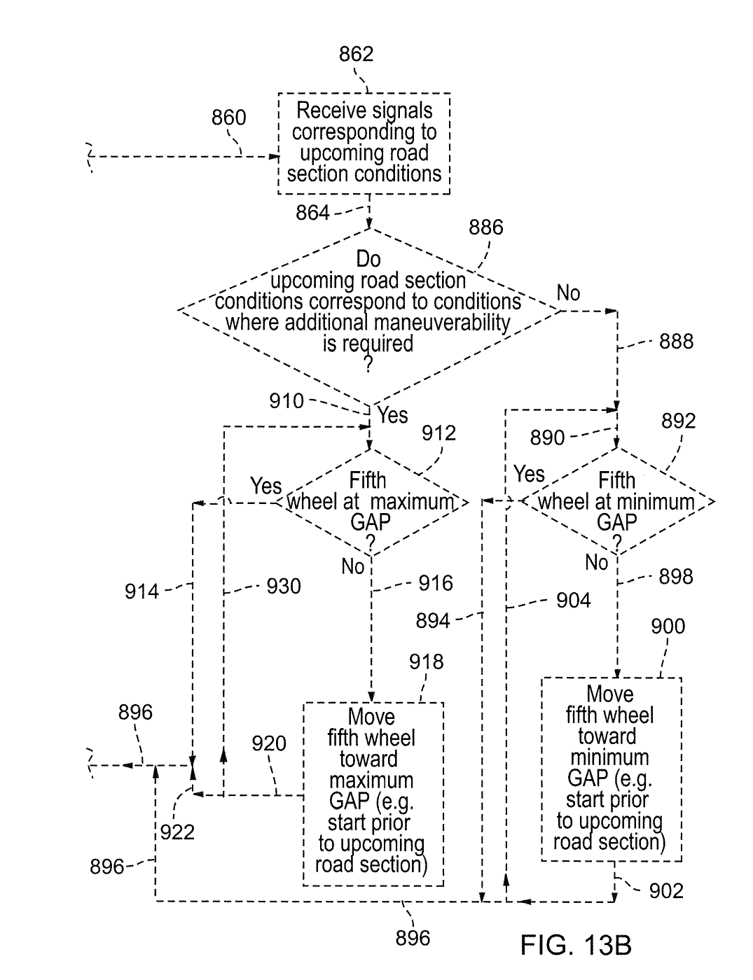

FIGS. 13A and 13B illustrates an exemplary control strategy that can be used for decreasing the fifth wheel gap in response to current vehicle conditions and also, optionally, based on upcoming road section conditions. In FIG. 13A, from a block 800, a line 802 is followed to a block 804. A block 804, signals are received corresponding to current vehicle conditions. Again, the current vehicle conditions can be as previously discussed. From block 804, a line 806 is followed to a block 808. At block 808 a determination is made as to whether current vehicle conditions correspond to conditions where additional maneuverability is required. If the answer at block 808 is yes, a process similar or identical to the previously described process for increasing the vehicle gap can be followed. For example, from block 808 a line 810 can be followed to a block 812. At block 812 a determination is made as to whether the fifth wheel is at its maximum gap position. If the answer is yes, a line 814 is followed to a line 816 and back to the line 802 with the process continuing. If the answer at block 812 is no, a line 818 is followed to a block 820. At block 820 the fifth wheel is moved toward its maximum gap position. From block 820 a line 822 can be followed back to line 816 with the process continuing. If the current vehicle conditions change such that additional maneuverability is no longer indicated, process blocks can be added that interrupt the movement of the fifth wheel before reaching the maximum gap position. Alternatively, from block 820, a line 822 can be followed to a line 824 and back to line 810 and block 812 with this loop being followed until the fifth wheel has been moved to its maximum gap position.

Returning to block 808, if the current vehicle conditions do not indicate that additional maneuverability is required, and an evaluation based on upcoming road conditions is not being made, a line 830 is followed to a block 832. At block 832 a determination is made as to whether the fifth wheel is at its minimum gap position. If the answer is yes, a line 834 is followed back to the line 816 with the process continuing as the fifth wheel is at its minimum maneuverability position and no additional maneuverability is required. Instead, if at block 832 the fifth wheel is not at its minimum gap position, a line 836 is followed to a block 838. At block 838 the fifth wheel is moved toward its minimum gap position. From block 838, a line 840 is followed back to line 816 with the process continuing. One or more additional process blocks can be included to interrupt the fifth wheel motion toward the minimum gap position if current conditions indicate that additional maneuverability is required. Alternately, from block 838, line 840 can be followed to a line 842 and back to line 830 and block 832 with the process continuing until the fifth wheel has been moved to a minimum gap position. If at line 836, one of the vehicle operating conditions was vehicle speed, for example vehicle speed dropping below a low-speed threshold, an optional line 844 can be followed to an optional block 846. At block 846 a determination is made as to whether the vehicle speed has risen from a low-speed threshold to a high-speed threshold. If the answer is yes, a line 848 is followed back to the line 836 with the process continuing via block 838. If the answer is no at block 846, a line 850 is followed to the line 840 with the process continuing as previously described. In this option, if the vehicle speed dropping below a low-speed threshold triggered the movement to a maximum gap position, a hysteresis is built into the system with the gap not being changed based on changes in vehicle speed until the speed has risen to the high-speed threshold.

Assume in FIG. 13A that upcoming road section conditions and their impact on maneuverability are also being evaluated by the control strategy. In this case, assuming the current vehicle conditions do not indicate that additional maneuverability is required, from block 808 and line 830 a line 860 is followed to a block 862 FIG. 13B. At block 862, signals corresponding to upcoming road section conditions are received. It should be noted that various process blocks can be combined with one another and are simply illustrated in the manner shown in these figures for convenience. For example, the signals in block 862 can be included in block 804. Also, the process steps need not necessarily be performed in the order indicated in the process flowcharts even though the illustrated order is desirable.

From block 862, a line 864 is followed to block 886. At block 886 a determination is made as to whether the upcoming road section conditions correspond to conditions where additional maneuverability is required (e.g., the vehicle is approaching a highly curved section of the road). If the answer at block 886 is no, a line 888 is followed to a line 890 and to a block 892. At block 892 a determination is made as to whether the fifth wheel is at its minimum gap position. If the answer is yes, a line 894 is followed to a line 896 and to line 840 (FIG. 13A) and via line 816 back to line 802 and block 804 with the process continuing. Under these conditions, both the current vehicle conditions and upcoming road section conditions do not indicate additional maneuverability is required and the fifth wheel is already at its minimum gap position and minimum maneuverability position. If at block 892 (FIG. 13B) the answer is no, meaning the fifth wheel is not at its minimum gap position, a line 898 is followed to a block 900. At block 900 the fifth wheel is moved toward the minimum gap position. This movement desirably starts prior to the upcoming road section, although the movement of the fifth wheel can start upon reaching the upcoming road section or be delayed (for example to start prior to or when an intermediate portion of the road section is reached where conditions indicate that less maneuverability is required). From block 900, a line 902 is followed to the line 896 with the process continuing (to FIG. 13A) as previously described. As an alternate strategy, from line 902 (FIG. 13B), a line 904 can be followed back to line 888 and via line 890 to block 892 and block 900. This loop can be followed until the fifth wheel has been moved to the minimum gap position. Process blocks can be included to interrupt the movement of the fifth wheel toward the minimum gap position if conditions change to indicate that additional maneuverability is indicated.

Returning to block 886 (FIG. 13B), assume that the upcoming road section conditions correspond to conditions where additional maneuverability is required. In this case, a line 910 from block 886 is followed to a block 912. At block 912 a determination is made as to whether the fifth wheel is at its maximum gap position. If the answer is yes, a line 914 is followed to the line 896. If the answer at block 912 is no, a line 916 is followed to a block 918 and the fifth wheel is moved toward the maximum gap position. For example, the movement of the fifth wheel toward the maximum gap position can start prior to the vehicle reaching the upcoming road section, when the vehicle reaches the upcoming road section, or can be delayed (for example to a time when the vehicle reaches the position within the road section where additional maneuverability is required). From block 918, a line 920 can be followed to a line 922 and to the line 896 (to FIG. 13A) and via the lines 840 and 816 back to line 802 and the block 804 with the process continuing. As an alternate strategy, from block 918 (FIG. 13B) a line 920 can be followed to a line 930 and back to line 910 and block 912 with this loop continuing until the fifth wheel has been moved to the maximum gap position.

It should be noted that these control strategies can be used to move the fifth wheel to positions intermediate the maximum minimum positions. For example, for a given current vehicle speed and road curvature, satisfactory maneuverability can result from positioning the fifth wheel at an intermediate position. In addition, delays can be built into the process as desired to insert a lag time between movement of the fifth wheel, especially toward minimum maneuverability positions, so that the fifth wheel is not continuously being moved. However, desirably there is no lag time if activation of an ABS system or a hand braking event is determined.

It should also be noted that the position of the fifth wheel can be determined from position sensors or otherwise. In addition, whether a fifth wheel is at a minimum or maximum position can be determined directly or indirectly. For example, in the case of an electric drive motor if the fifth wheel reaches a stop and drive motor current increases, this indicates the positioning of the fifth wheel at the maximum or minimum position. Also, determining whether the fifth wheel is at a maximum or minimum position before attempting to move the fifth wheel forward a maximum gap or forward a minimum gap is a desirable optional control strategy.

Again, the above illustrated control strategies are exemplary of strategies that can be used. The particular control strategy that is selected can be varied.

Having illustrated and described the principles of my invention with reference to a number of embodiments, it should be apparent to those of ordinary skill in the art that these embodiments may be modified in arrangement and detail without departing from these inventive principles. All such modifications fall within the scope of my developments.

In addition, the inventive principles also include novel and non-obvious method acts of fifth wheel position control described herein, both individually and in subcombinations and combinations with one another.

1. A vehicle for towing a trailer, the trailer having a front wall, the vehicle comprising:
a cab having a rear wall;
a fifth wheel positioned rearwardly of the rear wall;
a fifth wheel support coupled to the fifth wheel and mounted to the vehicle for movement in respective fore and aft directions toward and away from the rear wall to move the fifth wheel in the respective fore and aft directions with the movement of the fifth wheel support, wherein when the vehicle is towing a trailer coupled to the fifth wheel the movement of the fifth wheel support in a fore direction moves the fifth wheel and the trailer in the fore direction and reduces the gap between the rear wall of the cab and front wall of the towed trailer, and wherein when the vehicle is towing a trailer coupled to the fifth wheel the movement of the fifth wheel support in an aft direction moves the fifth wheel and trailer in the aft direction and increases the gap between the rear wall of the cab and the front wall of the trailer;
a fifth wheel drive for moving the fifth wheel support and thereby the fifth wheel in the fore and aft directions, the fifth wheel drive comprising a jack screw rotatable about its longitudinal axis in respective first and second opposite directions and coupled to the fifth wheel support such that rotation of the jack screw in the first direction moves the fifth wheel support and the fifth wheel in the fore direction and rotation of the jack screw in the second direction moves the fifth wheel support and the fifth wheel in the aft direction;
a motor drivenly coupled to the jack screw and operable in response to motor drive signals to rotate the jack screw in the first and second directions;
a motor controller providing motor drive signals to the motor in response to current vehicle signals corresponding to current vehicle operating conditions, the current vehicle operating conditions comprising at least one of a steering wheel steering angle and yaw rate of the vehicle.

2. A vehicle according to claim 1 wherein the current vehicle operating conditions correspond to at least one of a steering wheel steering angle, yaw rate of the vehicle, and whether an automatic braking system of the vehicle (ABS) is activated.

3. A vehicle according to claim 1 wherein the current vehicle operating conditions correspond to at least one of a steering wheel steering angle, yaw rate of the vehicle, whether an automatic braking system of the vehicle is activated, vehicle brake pedal position, and vehicle speed.

4. A vehicle according to claim 1 wherein the current vehicle operating conditions correspond to a group of current vehicle signals comprising at least all of a vehicle steering wheel steering angle, yaw rate of the vehicle, whether an automatic braking system of the vehicle is activated, vehicle brake pedal position, and vehicle speed.

5. A vehicle according to claim 4 wherein the fifth wheel controller is operable to provide motor drive signals to the motor to cause the motor to rotate the jack screw to move the fifth wheel toward the maximum gap position if the gap is not already at the maximum gap position in response to received input signals indicating that additional maneuverability will be required for the vehicle when the vehicle reaches an upcoming road section along which the vehicle will be traveling; wherein the fifth wheel controller is also operable to provide motor drive signals to the motor to cause the motor to rotate the jack screw to move the fifth wheel toward the minimum gap position if the gap is not at the minimum gap position in response to received inputs indicating that additional maneuverability will not be required for the vehicle when the vehicle reaches the upcoming road section and current vehicle signals do not correspond to conditions where additional maneuverability of the vehicle is required.

6. A vehicle according to claim 1 wherein the fifth wheel controller is operable to provide motor drive signals to the motor to cause the motor to rotate the jack screw to move the fifth wheel toward the maximum gap position if the gap is not already at the maximum gap position in response to received input signals indicating that additional maneuverability will be required for the vehicle when the vehicle reaches an upcoming road section along which the vehicle will be traveling; wherein the fifth wheel controller is also operable to provide motor drive signals to the motor to cause the motor to rotate the jack screw to move the fifth wheel toward the minimum gap position if the gap is not at the minimum gap position in response to received inputs indicating that additional maneuverability will not be required for the vehicle when the vehicle reaches the upcoming road section and current vehicle signals do not correspond to conditions where additional maneuverability of the vehicle is required.

7. A vehicle according to claim 6 in which data corresponding to road banking, road curvature, and speed limits of upcoming road sections of a road along which a vehicle will be traveling is stored, the fifth wheel control module being operable to provide motor drive signals to the motor to cause the motor to rotate the jack screw to move the fifth wheel toward the maximum gap position if the fifth wheel is not in the maximum gap position and if the stored data for the upcoming road section has a curvature in excess of a threshold for the speed limit corresponding to a road section, is banked in excess of a threshold for the speed limit along the banked section, or the speed limit is below a threshold.

8. A vehicle according to claim 1 in which data corresponding to road banking, road curvature, and speed limits of upcoming road sections of a road along which a vehicle will be traveling is stored, the fifth wheel control module being operable to provide motor drive signals to the motor to cause the motor to rotate the jack screw to move the fifth wheel toward the maximum gap position if the fifth wheel is not in the maximum gap position and if the stored data for the upcoming road section has a curvature in excess of a threshold for the speed limit corresponding to a road section, is banked in excess of a threshold for the speed limit along the banked section, or the speed limit is below a threshold.

9. A vehicle for towing a trailer, the trailer having a front wall, the vehicle comprising:
a cab having a rear wall;
a fifth wheel coupled to the vehicle rearwardly of the rear wall and movable in fore and aft directions toward and away from the rear wall, wherein when the vehicle is towing a trailer, the trailer is coupled to the fifth wheel and movement of the fifth wheel in a fore direction toward a minimum gap position decreases the spacing between the rear wall of the cab and the front wall of the trailer and movement of the fifth wheel in an aft direction toward a maximum gap position increases the gap between the rear wall of the cab and the front wall of the trailer;
a fifth wheel drive that is operably coupled to the fifth wheel for moving the fifth wheel in the respective fore and aft directions;
a fifth wheel controller coupled to the fifth wheel drive and operable to control the fifth wheel drive to cause the movement of the fifth wheel in the respective fore and aft directions;
the fifth wheel controller being operable to control the fifth wheel drive to move the fifth wheel toward the maximum gap position if the gap is not already at the maximum gap position in response to received inputs indicating that additional maneuverability will be required for the vehicle when the vehicle reaches an upcoming section of a road along which the vehicle is traveling.

10. A vehicle according to claim 9 wherein the fifth wheel controller is also operable to control the fifth wheel drive to move the fifth wheel toward the minimum gap position if the gap is not at the minimum gap position in response to received inputs indicating that additional maneuverability will not be required for the vehicle when the vehicle reaches the upcoming road section and wherein signals corresponding to current vehicle conditions delivered to the fifth wheel controller do not represent conditions where additional maneuvering is currently needed by the vehicle.

11. A vehicle according to claim 10 wherein the upcoming section of the road has curves and the wheel controller is operable to control the fifth wheel drive to move the fifth wheel toward the maximum gap position from the current gap position if the current gap position is not the maximum gap position.

12. A vehicle according to claim 10 wherein the upcoming section of the road has a lower speed limit than the section of the road along which the vehicle is currently traveling and the fifth wheel controller is operable to control the fifth wheel drive to move the fifth wheel toward the maximum gap position from the current gap position if the current gap position is not the maximum gap position.

13. A vehicle according to claim 9 wherein the fifth wheel controller is operable to control the fifth wheel drive to move the fifth wheel in response to information on upcoming road sections stored in a map data base.

14. A vehicle according to claim 10 wherein the upcoming section of the road is straighter than the current road section along which the vehicle is currently traveling, and wherein the fifth wheel controller is operable to control the fifth wheel drive to move the fifth wheel toward the minimum gap position from the current gap position if the current gap position is not the minimum gap position.

15. A vehicle according to claim 10 wherein the upcoming section of the road is straighter than the current road section along which the vehicle is currently traveling, and wherein the fifth wheel controller is operable to control the fifth wheel drive to move the fifth wheel toward the minimum gap position from the current gap position if the current gap position is not the minimum gap position and the current vehicle conditions do not indicate a high maneuverability event selected from the group comprising activation of an automatic braking system, a hard braking event corresponding to a brake pedal position exceeding a threshold brake pedal position, a steering angle in excess of a threshold and at least one yaw rate sensor indicating a vehicle yaw rate in excess of a threshold.

16. A vehicle according to claim 10 wherein the upcoming section of the road has a lower speed limit than the road section along which the vehicle is currently traveling, and wherein the fifth wheel controller is operable to control the fifth wheel drive to move the fifth wheel toward the minimum gap position from the current gap position if the current gap position is not the minimum gap position.

17. A vehicle according to claim 9 wherein the upcoming section of the road has a higher speed limit than the road section along which the vehicle is currently traveling, and wherein the fifth wheel controller is operable to control the fifth wheel drive to move the fifth wheel toward the minimum gap position from the current gap position if the current gap position is not the minimum gap position and the current vehicle conditions do not indicate a high maneuverability event selected from the group comprising activation of an automatic braking system, a hard braking event corresponding to a brake pedal position exceeding a threshold brake pedal position, a steering angle in excess of a threshold, and at least one yaw rate sensor indicating a vehicle yaw rate in excess of a threshold.

18. A vehicle according to claim 10 wherein the upcoming section of the road has a lower speed limit than the speed limit of the road section along which the vehicle is currently traveling, the lower speed limit being lower than a low speed threshold, and wherein the fifth wheel controller is operable to control the fifth wheel drive to move the fifth wheel the maximum gap position if the speed limit of the upcoming road section does not exceed a low speed threshold.

19. A vehicle according to claim 10 wherein the upcoming section of the road has a higher speed limit than the road section along which the vehicle is currently traveling, and wherein the fifth wheel controller is operable to control the fifth wheel drive to move the fifth wheel the minimum gap position if the speed limit of the upcoming road section exceeds a high speed threshold.

20. A vehicle according to claim 9 wherein the fifth wheel controller is operable to control the fifth wheel drive to move the fifth wheel toward the minimum gap position if the current speed exceeds a high speed threshold and the current vehicle operating conditions do not indicate a high maneuverability event selected from the group comprising cycling of an automatic braking system, a hard braking event corresponding to a brake pedal position at a threshold brake position, a steering angle in excess of a threshold and at least one yaw rate sensor indicating a vehicle yaw rate in excess of a threshold.

21. A vehicle according to claim 10 in which the fifth wheel controller is operable in response to current vehicle signals corresponding to current vehicle operating conditions to cause the fifth wheel drive to move the fifth wheel toward the maximum gap position if the gap is not already at the maximum gap position in response to received current vehicle signals indicating that additional maneuverability is required for the vehicle, the fifth wheel being operable in response to current vehicle signals corresponding to current vehicle conditions to cause the fifth wheel drive to move the fifth wheel toward the minimum gap position if the gap is not already at the minimum gap position in response to received current vehicle signals indicating that additional maneuverability is not required for the vehicle and in the absence of input signals indicating that additional maneuverability will be required for the vehicle when the vehicle reaches an upcoming section of a road along which the vehicle is traveling.

22. A vehicle according to claim 20 wherein the current vehicle signals correspond to or indicate at least one of a vehicle steering angle exceeding a threshold steering angle and vehicle yaw rate in excess of a yaw rate threshold.

23. A vehicle according to claim 20 wherein the current vehicle signals correspond to or indicate at least one of a vehicle steering angle exceeding a threshold steering angle, vehicle yaw rate in excess of a yaw rate threshold and whether an automatic braking system is activated.

24. A vehicle according to claim 20 wherein the current vehicle signals correspond to or indicate at least one of a vehicle steering angle exceeding a threshold steering angle, vehicle yaw rate in excess of a vehicle yaw rate threshold, whether an automatic braking system is activated, whether the vehicle brakes are being applied in excess of a brake threshold, and vehicle speed.

25. A vehicle according to claim 24 wherein the current vehicle signals correspond to or indicate a group of current vehicle signals consisting at least of a vehicle steering angle exceeding a threshold steering angle, vehicle yaw rate in excess of a vehicle yaw rate threshold, whether an automatic braking system is activated, whether the vehicle brakes are being applied in excess of a threshold, and vehicle speed.

26. A vehicle for towing a trailer, the trailer having a front wall, the vehicle comprising:
a cab having a rear wall;
a fifth wheel positioned rearwardly of the rear wall;
a fifth wheel support coupled to the fifth wheel and mounted to the vehicle for movement in respective fore and aft directions toward and away from the rear wall to move the fifth wheel in the respective fore and aft directions with the movement of the fifth wheel support, wherein when the vehicle is towing a trailer coupled to the fifth wheel the movement of the fifth wheel support in a fore direction moves the fifth wheel and the trailer in the fore direction and reduces the gap between the rear wall of the cab and front wall of the towed trailer, and wherein when the vehicle is towing a trailer coupled to the fifth wheel the movement of the fifth wheel support in an aft direction moves the fifth wheel and trailer in the aft direction and increases the gap between the rear wall of the cab and the front wall of the trailer, the fifth wheel being movable in either direction between a maximum gap position and a minimum gap position;
a fifth wheel drive for moving the fifth wheel support and thereby the fifth wheel in the fore and aft directions, the fifth wheel drive comprising a jack screw rotatable about its longitudinal axis in respective first and second opposite directions and coupled to the fifth wheel support such that rotation of the jack screw in the first direction moves the fifth wheel support and the fifth wheel in the fore direction and rotation of the jack screw in the second direction moves the fifth wheel support and the fifth wheel in the aft direction, the fifth wheel drive also comprising a motor drivenly coupled to the jack screw and operable in response to motor drive signals to rotate the jack screw in the first and second directions;
a motor controller operable to control the fifth wheel drive to cause respective fore and aft direction movement of the fifth wheel;
wherein in response to a signal indicating the activation of an automatic braking system, the motor controller is operable to cause the fifth wheel drive to move the fifth wheel support and thereby the fifth wheel toward the maximum gap position if the fifth wheel is not in the maximum gap position.

27. A vehicle for towing a trailer, the trailer having a front wall, the vehicle comprising:
a cab having a rear wall;
a fifth wheel positioned rearwardly of the rear wall;
a fifth wheel support coupled to the fifth wheel and mounted to the vehicle for movement in respective fore and aft directions toward and away from the rear wall to move the fifth wheel in the respective fore and aft directions with the movement of the fifth wheel support, wherein when the vehicle is towing a trailer coupled to the fifth wheel the movement of the fifth wheel support in a fore direction moves the fifth wheel and the trailer in the fore direction and reduces the gap between the rear wall of the cab and front wall of the towed trailer, and wherein when the vehicle is towing a trailer coupled to the fifth wheel the movement of the fifth wheel support in an aft direction moves the fifth wheel and trailer in the aft direction and increases the gap between the rear wall of the cab and the front wall of the trailer, the fifth wheel being movable in either direction between a maximum gap position and a minimum gap position;
a fifth wheel drive for moving the fifth wheel support and thereby the fifth wheel in the fore and aft directions, the fifth wheel drive comprising a jack screw rotatable about its longitudinal axis in respective first and second opposite directions and coupled to the fifth wheel support such that rotation of the jack screw in the first direction moves the fifth wheel support and the fifth wheel in the fore direction and rotation of the jack screw in the second direction moves the fifth wheel support and the fifth wheel in the aft direction, the fifth wheel drive also comprising a motor drivenly coupled to the jack screw and operable in response to motor drive signals to rotate the jack screw in the first and second directions;
a motor controller operable to control the fifth wheel drive to cause respective fore and aft direction movement of the fifth wheel;
wherein in response to signals corresponding to current steering angle and current vehicle speed, the motor controller is operable to cause the fifth wheel drive to move the fifth wheel toward the maximum fifth wheel position, if the fifth wheel is not in the maximum position, in the event the steering wheel angle exceeds a threshold steering wheel angle for the current vehicle speed.

28. A vehicle for towing a trailer, the trailer having a front wall, the vehicle comprising:
a cab having a rear wall;
a fifth wheel positioned rearwardly of the rear wall;
a fifth wheel support coupled to the fifth wheel and mounted to the vehicle for movement in respective fore and aft directions toward and away from the rear wall to move the fifth wheel in the respective fore and aft directions with the movement of the fifth wheel support, wherein when the vehicle is towing a trailer coupled to the fifth wheel the movement of the fifth wheel support in a fore direction moves the fifth wheel and the trailer in the fore direction and reduces the gap between the rear wall of the cab and front wall of the towed trailer, and wherein when the vehicle is towing a trailer coupled to the fifth wheel the movement of the fifth wheel support in an aft direction moves the fifth wheel and trailer in the aft direction and increases the gap between the rear wall of the cab and the front wall of the trailer, the fifth wheel being movable in either direction between a maximum gap position and a minimum gap position;
a fifth wheel drive for moving the fifth wheel support and thereby the fifth wheel in the fore and aft directions, the fifth wheel drive comprising a jack screw rotatable about its longitudinal axis in respective first and second opposite directions and coupled to the fifth wheel support such that rotation of the jack screw in the first direction moves the fifth wheel support and the fifth wheel in the fore direction and rotation of the jack screw in the second direction moves the fifth wheel support and the fifth wheel in the aft direction, the fifth wheel drive also comprising a motor drivenly coupled to the jack screw and operable in response to motor drive signals to rotate the jack screw in the first and second directions;
a motor controller operable to control the fifth wheel drive to cause respective fore and aft direction movement of the fifth wheel;
the fifth wheel controller also being operable to control the fifth wheel drive to move the fifth wheel toward the maximum gap position if the gap is not already at the maximum gap position in response to received input signals indicating that additional maneuverability will be required for the vehicle when the vehicle reaches an upcoming section of a road along which the vehicle is traveling, wherein the input signals indicating that additional maneuverability will be required comprise at least the curvature of the upcoming road section and the speed limit for the upcoming road section, the fifth wheel controller also being operable to control the fifth wheel drive to move the fifth wheel toward the minimum gap position if the gap is not at the minimum gap position in response to received inputs indicating that additional maneuverability will not be required for the vehicle when the vehicle reaches the upcoming road section and current vehicle signals provided to the controller do not correspond to current vehicle conditions for which increased maneuverability is required.
